(19) United States
(12) Patent Application Publication
(10) Pub. No.: US 2019/0293421 A1
(43) Pub. Date: Sep. 26, 2019

(54) Frequency detection method based on synchronous oscillation of resonators and tilt sensor using the frequency detection method

(71) Applicant: XI'AN JIAOTONG UNIVERSITY, Xi'an, Shaanxi (CN)

(72) Inventors: Xueyong Wei, Xi'an, Shaanxi (CN); Yinsheng Weng, Xi'an, Shaanxi (CN); Shudong Wang, Xi'an, Shaanxi (CN); Dong Pu, Xi'an, Shaanxi (CN); Zhuangde Jiang, Xi'an, Shaanxi (CN)

(73) Assignee: XI'AN JIAOTONG UNIVERSITY, Xi'an ,Shaanxi (CN)

(21) Appl. No.: 16/465,576

(22) PCT Filed: Dec. 29, 2017
(86) PCT No.: PCT/CN2017/120360

§ 371 Date: May 31, 2019

(30) Foreign Application Priority Data
Apr. 10, 2017 (CN) 201710231210.5

(51) Int. Cl. G01C 9/06; G01P 15/18

(52) U.S. Cl. CPC G01C 9/06; G01P 15/18

(57) ABSTRACT

A frequency detection method based on synchronous oscillation of resonators, and a tilt sensor using the frequency detection method are disclosed. The sensor includes a detecting unit and a synchronization unit which are respectively disposed in a first oscillating circuit and a second oscillating circuit for forming two self-excited oscillators. The detecting unit and the synchronization unit are electrostatically coupled through a plate capacitor to allow a weak synchronous current to pass through, which affects and reduces phase noise of the self-excited oscillator formed by the detecting unit, thereby greatly improving the frequency stability thereof and simultaneously reading out a natural frequency thereof through a frequency counter. Three detecting units are respectively evenly distributed at a periphery of a hexagonal mass block through magnifying beams. The mass block is configured to sense a gravitational acceleration. The gravitational acceleration is converted into a compressive or tension stress to be applied to the magnifying beams, and then the stress is amplified by the magnifying beams to be applied to the detecting units, so as to change a self-oscillation frequency of the detecting units for forming three synchronous self-oscillation circuits. Through the oscillation frequency and the oscillation frequency variation of the three synchronous self-oscillation circuits, the acceleration magnitude and direction of the entire sensor are deduced.

### CROSS REFERENCE OF RELATED APPLICATION

This is a U.S. National Stage under 35 U.S.C 371 of the International Application PCT/CN2017/120360, filed Dec. 29, 2017, which claims priority under 35 U.S.C. 119(a-d) to CN 201710231210.5, filed Apr. 10, 2017.

### BACKGROUND OF THE PRESENT INVENTION

### Field of Invention

The present invention relates to the field of tilt sensor technology, and more particularly to a frequency detection method based on synchronous oscillation of resonators and a tilt sensor using the frequency detection method.

### Description of Related Arts

The importance of the tilt sensor, and especially the high-precision full-range tilt sensor, is self-evident. In 2015, Chinese Premier Li, Keqiang put forward the “Made in China 2025” grand plan, clarified the strategic task of building a powerful manufacturing country, and pointed out nine strategic focuses, wherein three fields, including high-end CNC (computer numerical control) machine tools and robots, aerospace equipment, and high-performance medical devices, are closely related to sensors, and especially high-precision tilt sensors. It can be said that achieving high-precision full-range tilt sensor is one of the important conditions for building a strong country.

As a high-precision sensor, the resonant MEMS (micro-electromechanical system) tilt sensor has been favored and valued by researchers all over the world. It generally includes a sensitive component, a resonant component, and a signal processing circuit. The sensitive component of the sensor is configured to sense the in-plane gravitational acceleration. The gravity signal is converted into frequency data by the resonant component, and then processed by the signal processing circuit to deduce the angle value. For the resonant tilt sensor, its measurement performance is affected by the topological structure of the sensitive component, the processing technology, the driving and detection principle, and the frequency stability of the oscillator. In the majority of cases, the resonant frequency shift caused by the change of the weak gravitational acceleration is submerged in the background noise of the closed-loop oscillator, resulting in inaccurately measuring the microgravity variation. Therefore, in the past decade, researchers in various countries have been trying to improve the scale factor of the tilt sensor and exploring new ways to reduce the background noise of the oscillator.

In 2013, the applicant and his collaborators at Cambridge University discovered the effects of mode coupling and nonlinear amplitude saturation on improving the frequency stability of silicon micro-oscillator in different topologies. In the same year, the collaborators of the applicant of this patent designed two micro-tuning fork beam oscillators that interacted by electrostatic forces, and observed the synchronization phenomenon in MEMS for the first time. At the same time, it was found that the synchronization boosted the frequency stability of the oscillator and decreased the background noise floor.

Based on the published patent CN 105737811 A, the applicant of the present application optimizes and improves the theory and practice, and introduces the synchronous measurement principle into the design, processing and testing of the tilt sensor, so as to construct a new generation full-scale tilt sensor, which is capable of increasing two orders of magnitude based on previous measurement accuracy and achieving an angle (gravity acceleration) measurement with a resolution of 10⁻⁵ degrees (170 ng).

### SUMMARY OF THE PRESENT INVENTION

In order to further improve the measurement accuracy of the prior art, an object of the present invention is to provide a frequency detection method based on synchronous oscillation of resonators and a tilt sensor using the frequency detection method, which is able to realize full-scale and ultra-high-precision measurement of an in-plane inclination angle.

To achieve the above object, the present invention provides a technical solution as follows.

An MEMS (micro-electromechanical system) full-scale tilt sensor based on synchronous oscillation frequency detection comprises: a mass block for sensing a gravitational acceleration, three pairs of magnifying beams, three detecting units and three synchronization units, wherein the three pairs of magnifying beams, the three detecting units and the three synchronization units are respectively distributed at a periphery of the mass block; the gravitational acceleration sensed by the mass block is converted into a stress or tension to be applied to the three pairs of magnifying beams, and then is amplified by the three pairs of magnifying beams to be applied to the three detecting units, so as to change a rigidity and an inherent frequency of the three detecting units.

Each of the three detecting units comprises a detecting harmonic oscillator, a first capacitor plate and a second capacitor plate both of which are respectively located at two sides of the detecting harmonic oscillator, a first fixed anchor at a top end of the detecting harmonic oscillator, a second fixed anchor, a first metal electrode pad sputtered on the first fixed anchor, a third capacitor plate located at an opposite side of the first capacitor plate and fixed to the second fixed anchor, and a second metal electrode pad sputtered on the second fixed anchor, wherein two ends of the detecting harmonic oscillator are respectively connected with a corresponding pair of magnifying beams and the first fixed anchor; the first capacitor plate and the third capacitor plate form a first plate capacitor.

Each of the three synchronization units comprises a synchronization harmonic oscillator, a fourth capacitor plate and a fifth capacitor plate both of which are respectively located at two sides of the synchronization harmonic oscillator, a third fixed anchor and a fifth fixed anchor both of which are respectively located at a top end and a bottom end of the synchronization harmonic oscillator, a fourth fixed anchor, a third metal electrode pad sputtered on the third fixed anchor, a sixth capacitor plate located at an opposite side of the fourth capacitor plate and fixed to the fourth fixed anchor, a fourth metal electrode pad sputtered on the fourth fixed anchor, wherein the fourth capacitor plate and the sixth capacitor plate form a second plate capacitor, the fifth capacitor plate is opposite to the second capacitor plate to form a third plate capacitor.

An oscillating circuit with automatic gain control comprises a feedthrough current cancellation circuit, an amplifier, a bandpass filter, a phase shifting circuit, a comparator and an amplitude adjustment circuit connected with each other in sequence, wherein the feedthrough current cancellation circuit is connected with the first metal electrode pad or the third metal electrode pad, the amplitude adjustment circuit is connected with the second metal electrode pad or the fourth metal electrode pad.

The sensor comprises a monocrystalline silicon substrate, an insulating layer grown on the monocrystalline silicon substrate, and a monocrystalline silicon structural layer grown on the insulating layer, wherein the monocrystalline silicon structural layer comprises the hexagonal mass block, the three pairs of magnifying beams, the three detecting units and the three synchronization units; the monocrystalline silicon substrate plays a support role for ensuring that the monocrystalline silicon structural layer is hung and is able to freely vibrate.

One pair of the three pairs of magnifying beams, one of the three detecting units and one of the three synchronization units form a whole; and the three pairs of magnifying beams, the three detecting units and the three synchronization units are respectively radially evenly distributed at the periphery of the mass block as the whole.

The distance between the first capacitor plate and the third capacitor plate, the distance between the fourth capacitor plate and the sixth capacitor plate, and the distance between the fifth capacitor plate and the second capacitor plate are in a range of 0.1-2 μm.

When a natural frequency ratio of the synchronization harmonic oscillator to the detecting harmonic oscillator is 1:1, 3:1 or 9:1, a stability improvement effect of the oscillator is most significant.

An angle measurement method of an MEMS (micro-electromechanical system) full-scale tilt sensor based on synchronous oscillation frequency detection comprises steps of: a mass block sensing an in-plane gravitational acceleration and simultaneously generating a stress or tension to three pairs of magnifying beams, the three pairs of magnifying beams amplifying the stress or tension and then applying to three detecting units, changing an inherent frequency of a detecting harmonic oscillator of each of the three detecting units, respectively disposing each of the three detecting units and each of three synchronization units in a first oscillating circuit and a second oscillating circuit with automatic gain control, forming three synchronous self-oscillation circuits, detecting an oscillating frequency and an oscillating frequency variation of each of the three synchronous oscillating circuits, and deducing an inclination value of the sensor.

The first oscillating circuit and the second oscillating circuit are synchronously vibrated through an electrostatic coupling of the third plate capacitor, so as to greatly reduce a background noise of the first oscillating circuit and the second oscillating circuit for improving a frequency stability of the three detecting units; when a self-oscillating frequency ratio of the first oscillating circuit and the second oscillating circuit is 1:1, 1:3 or 1:9, the frequency variation of the three detecting units is synchronously amplified, so as to improve a detection sensitivity of the three detecting units.

Compared with the prior art, the present invention has beneficial effects as follows. The sensor provided by the present invention comprises three detecting units as well as three synchronization units respectively electrostatically coupled with the three detecting units, so that when a mass block senses an in-plane gravitational acceleration, a stress or tension is generated, and then amplified by three pairs of magnifying beams, and then applied to three detecting units to change an inherent frequency of the three detecting units. Since each of the three detecting units and each of the three synchronization units are respectively disposed in a first oscillating circuit and a second oscillating circuit with automatic gain control, three synchronous self-oscillation circuits are formed. Through detecting an oscillating frequency and an oscillating frequency variation of each of the three synchronous oscillating circuits, an inclination value of the sensor is deduced. The oscillator based on silicon microresonator is stable in frequency, low in noise and easy to be integrated, so the tilt sensor based on the oscillator is small in volume, high in sensitivity and large in measuring range; the frequency detection method based on synchronous oscillation of resonators is able to achieve lower background noise and higher frequency stability, so as to achieve ultra-precise tilt measurement.

### BRIEF DESCRIPTION OF THE DRAWINGS

FIG. 1 is a structurally schematic view of the present invention.

FIG. 2 is a top view of a monocrystalline silicon structural layer of the present invention.

FIG. 3 is a schematic diagram of a measuring circuit of the present invention.

FIG. 4 is a schematic diagram of an improved measuring circuit of the present invention.

### DETAILED DESCRIPTION OF THE PREFERRED EMBODIMENT

The present invention will be further described in detail with accompanying drawings as follows.

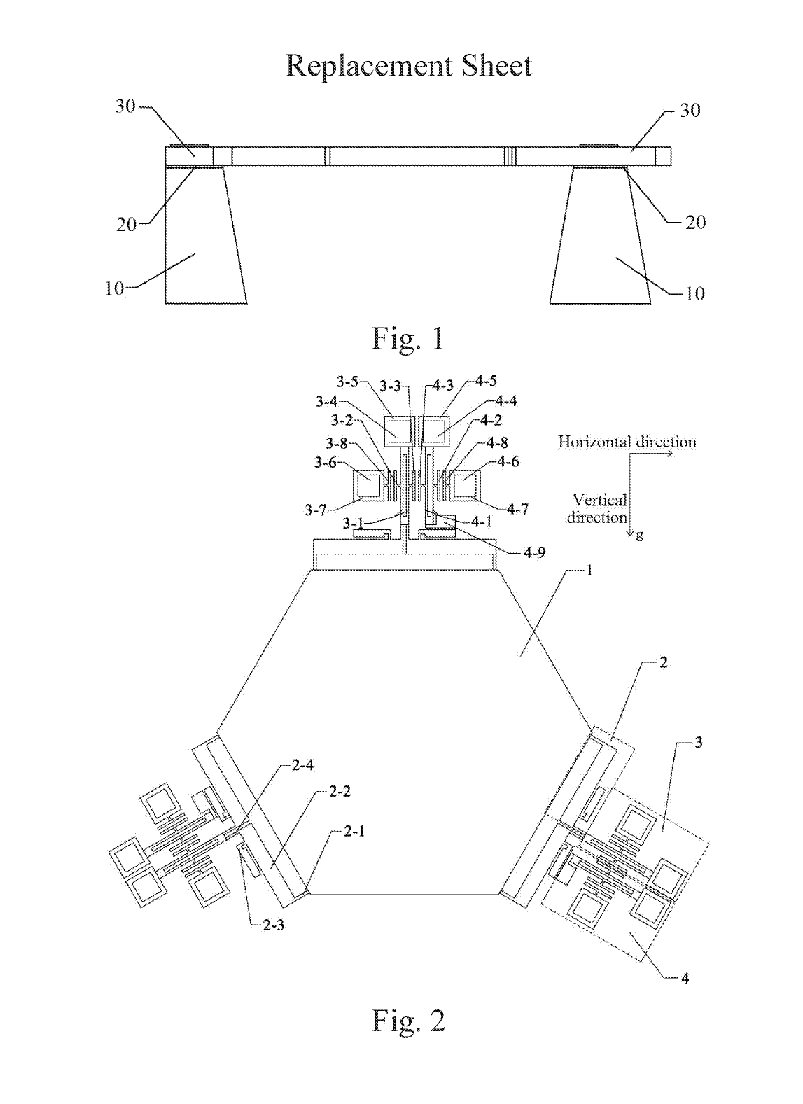

Referring to FIG. 1, an MEMS (micro-electromechanical system) full-range tilt sensor based on synchronous oscillation frequency detection comprises a monocrystalline silicon substrate 01 with a thickness in a range of 400-1000 μm, a silicon dioxide insulating layer 02 grown on the monocrystalline silicon substrate 01 with a thickness in a range of 2-3 μm, and a monocrystalline silicon structural layer 03 with a thickness in a range of 10-25 μm.

Referring to FIG. 2, the monocrystalline silicon structural layer 03 is a core part of the sensor and comprises a hexagonal mass block 1, three pairs of magnifying beams 2, three detecting units 3 and three synchronization units 4. The mass block 1 is configured to sense an in-plane gravitational acceleration and convert the in-plane gravitational acceleration into a stress or tension to be applied to the three pairs of magnifying beams 2. One pair of the three pairs of magnifying beams 2, one of the three detecting units 3 and one of the three synchronization units 4 form a whole; and the three pairs of magnifying beams 2, the three detecting units 3 and the three synchronization units 4 are distributed 1s radially evenly distributed at a periphery of the hexagonal mass block 1 as the whole; that is to say, the whole, formed by one pair of the three pairs of magnifying beams 2, one of the three detecting units 3 and one of the three synchronization units 4, is located at an edge of the hexagonal mass block 1. The hexagonal mass block 1 is hung and only supported by one end of the three pairs of magnifying beams 2, and the other end of the three pairs of magnifying beams 2 is connected with the three detecting units 3.

Every magnifying beam 2 comprises an input beam 2-1, a lever 2-2, an anchor beam 2-3 and an output beam 2-4, wherein the input beam 2-1 is connected with the hexagonal mass block 1 and acts as an input end of the stress or tension, the stress or tension is amplified by the lever 2-2 and the anchor beam 2-3 to be applied to one end of the output beam 2-4, the other end of the output beam 2-4 is connected with a detecting harmonic oscillator 3-1; a thinner end portion of the anchor beam 2-3, where the anchor beam 2-3 is connected with the lever 2-2, is hung to play a support role; a thicker end portion of the anchor beam 2-3 is connected with the monocrystalline silicon substrate 01 to play a fixed role. Specifically, in the whole, formed by one pair of the three pairs of magnifying beams 2, one of the three detecting units 3 and one of the three synchronization units 4, there are a pair of input beams 2-1 which are connected with the hexagonal mass block 1 and respectively located at two ends of one edge of the hexagonal mass block 1, the lever 2-2 is inwardly extended from the input beam, also, there are a pair of output beams 2-4 each of which is connected with a corresponding lever 2-2 and a corresponding anchor beam 2-3. One end of the lever 2-2 is connected with the input beam 2-1 and the other end of the lever 2-2 is connected with the output beam 2-4.

As shown in FIG. 2, Each of the three detecting units 3 comprises a detecting harmonic oscillator 3-1 which is a main part of each of the three detecting units 3, a first capacitor plate 3-2 and a second capacitor plate 3-3 both of which are respectively located at two sides of the detecting harmonic oscillator 3-1, a first fixed anchor 3-5 at a top end of the detecting harmonic oscillator 3-1, a first metal electrode pad 3-4 sputtered on the first fixed anchor 3-5, a third capacitor plate 3-8 opposite to the first capacitor plate 3-2, a second fixed anchor 3-7, and a second metal electrode pad 3-6 sputtered on the second fixed anchor 3-7, wherein the first capacitor plate 3-2 and the third capacitor plate 3-8 form a first plate capacitor, and the third capacitor plate 3-8 is fixed to the second fixed anchor 3-7.

As shown in FIG. 2, each of the three synchronization units 4 is similar to each of the three detecting units 3 in structure and comprises a synchronization harmonic oscillator 4-1 which is a main part of each of the synchronization units 4, a fourth capacitor plate 4-2 and a fifth capacitor plate 4-3 both of which are located at two sides of the synchronization harmonic oscillator 4-1, a third fixed anchor 4-5 at a top end of the synchronization harmonic oscillator 4-1, a third metal electrode pad 4-4 sputtered on the third fixed anchor 4-5, a sixth capacitor plate 4-8 opposite to the fourth capacitor plate 4-2, a fourth fixed anchor 4-7, and a fourth metal electrode pad 4-6 sputtered on the fourth fixed anchor 4-7, wherein the fourth capacitor plate 4-2 and the sixth capacitor plate 4-8 form a second plate capacitor, the sixth capacitor plate 4-8 is fixed to the fourth fixed anchor 4-7, the fifth capacitor plate 4-3 is opposite to the second capacitor plate 3-3 to form a third plate capacitor, so as to synchronously transfer signals. Each of the synchronization units 4 further comprises a fifth fixed anchor 4-9 at a bottom end of the synchronization harmonic oscillator 4-1, a thinner portion of the fifth fixed anchor 4-9 plays a connection role, that is, the thinner portion of the fifth fixed anchor 4-9 is connected with the synchronization harmonic oscillator 4-1 and is hung; the thicker portion of the fifth fixed anchor 4-9 is connected with the monocrystalline silicon substrate 01 for fixing.

Referring to FIG. 2, each of the first fixed anchor, the second fixed anchor, the third fixed anchor and the fourth fixed anchor is square and has a side length in a range of 180-600 μm; the fifth fixed anchor is polygonal; every metal electrode pad is a square with a smaller area than a corresponding fixed anchor, and has a side length in a range of 150-250 μm; a length of every capacitor plate is in a range of 50-200 μm; the distance between the first capacitor plate 3-2 and the third capacitor plate 3-8, the distance between the fourth capacitor plate 4-2 and the sixth capacitor plate 4-8, and the distance between the fifth capacitor plate 4-3 and the second capacitor plate 3-3 are in a range of 0.1-2 μm.

As shown in FIG. 2, the harmonic oscillator for inclination measurement is generally a double-ended fixed resonant tuning fork, and however, for the present invention, any suitable beam resonator or bulk modal resonator can be employed.

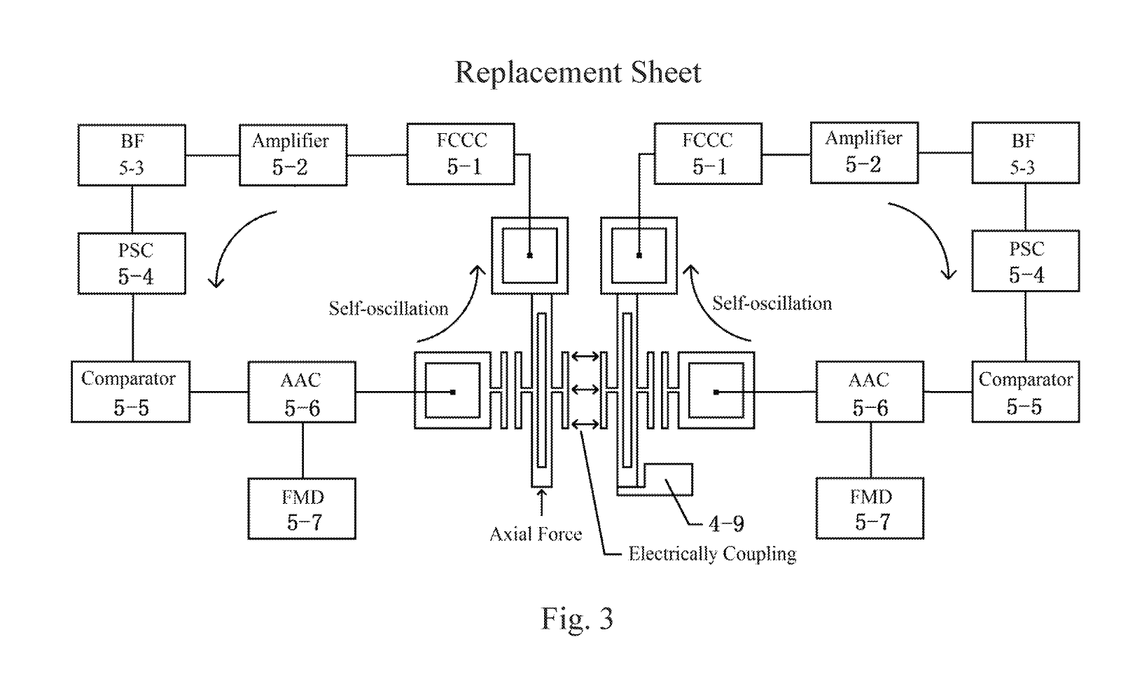

Referring to FIG. 3, each of the three detecting units 3 and each of the three synchronization units 4 are respectively disposed in a first oscillating circuit and a second oscillating circuit with automatic gain control. Every oscillating circuit comprises a Feedthrough current cancellation circuit (FCCC) 5-1, an amplifier 5-2, a bandpass filter (BF) 5-3, a phase shifting circuit (PSC) 5-4, a comparator 5-5 and an amplitude adjustment circuit (AAC) 5-6 connected with each other in sequence. Under specific circuit parameters, each of the three detecting units 3 and each of the three synchronization units 4 respectively cooperate with the first oscillating circuit and the second oscillating circuit to form a synchronous self-oscillation circuit whose oscillating frequency is a natural frequency of the harmonic oscillator which is able to be read out by a frequency measuring device (FMD) 5-7.

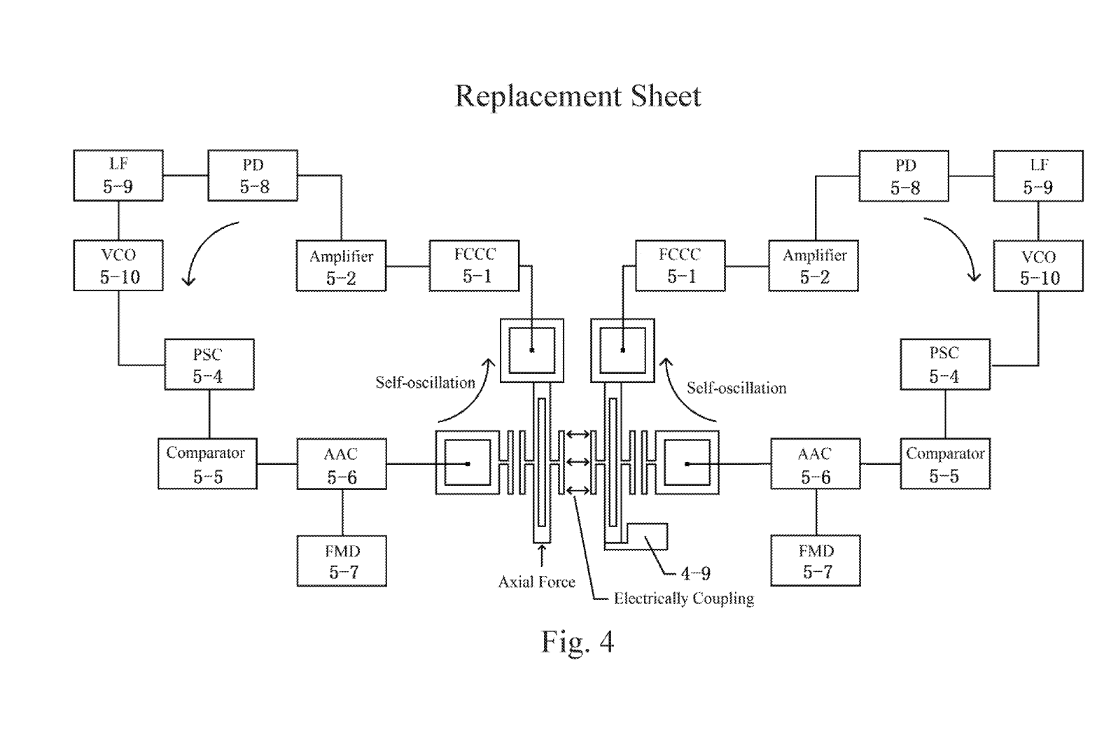

Referring to FIG. 4, based on the above test method, a PLL (phase-lock loop) is added. The PLL comprises a PD (phase discriminator) 5-8, an LF (loop filter) 5-9 and a VCO (voltage controlled oscillator) 5-10 and acts as the bandpass filter with high Q (quality factor) to replace the bandpass filter 5-3, so as to make the background noise smaller and the frequency stability higher.

The working principle of the present invention is described as follows.

When the hexagonal mass block 1 senses the in-plane gravitational acceleration, it simultaneously generates the stress or tension on the three pairs of magnifying beams 2; and then the stress or tension is transmitted and amplified through the three pairs of magnifying beams 2 to be applied to the detecting units 3, so as to change the natural frequency of every detecting harmonic oscillator 3-1. Since three detecting harmonic oscillators and three synchronization harmonic oscillators are respectively disposed in three first oscillating circuits and three second oscillating circuits with automatic gain control to form three synchronous self-oscillation circuits, the oscillating frequency and the oscillating frequency variation of the three synchronous self-oscillation circuits are detected to deduce the inclination value of the entire sensor.

When the three synchronization units 4 do not work, the hexagonal mass block 1, the three pairs of magnifying beams 2, the three detecting units 3 and three first oscillating circuits form a complete inclination test system. However, due to the noise present in the silicon micro-oscillator itself and the drift caused by the external environment, the test accuracy of the complete inclination test system is subject to certain restrictions (referring to CN 105737811 A). When the synchronization units 4 work, the self-oscillation is generated in the closed loop circuit at the natural frequency of the synchronization harmonic oscillators 4-1, each of the three detecting units 3 and each of the synchronization units 4 are respectively electrostatically coupled to form synchronous self-oscillation. When a natural frequency ratio of the synchronization harmonic oscillator 4-1 to the detecting harmonic oscillator 3-1 is 1:1, 3:1 or 9:1, the synchronous effect is best; and at this time, the frequency stability of the oscillator formed by the detecting harmonic oscillator 3-1 will be greatly improved, and the signal-to-noise ratio of the frequency signal read out by the frequency measuring device 5-7 will be greatly improved, thereby improving the test accuracy of the tilt sensor.

1-10. (canceled)

11: An MEMS (micro-electromechanical system) full-scale tilt sensor based on synchronous oscillation frequency detection, which comprises:
a mass block for sensing a gravitational acceleration, three pairs of magnifying beams, three detecting units and three synchronization units, wherein the three pairs of magnifying beams, the three detecting units and the three synchronization units are respectively distributed at a periphery of the mass block; the three detecting units are respectively coupled with the three synchronization units; the three detecting units and the three synchronization units are respectively disposed in three first oscillating circuits and three second oscillating circuits with automatic gain control to form self-oscillation; the gravitational acceleration sensed by the mass block is converted into a stress or tension to be applied to the three pairs of magnifying beams, and then is amplified by the three pairs of magnifying beams to be applied to the three detecting units.

12: The MEMS full-scale tilt sensor based on synchronous oscillation frequency detection, as recited in claim 11, wherein: each of the three detecting units comprises a detecting harmonic oscillator which is a main part of each of the three detecting units, a first capacitor plate and a second capacitor plate both of which are respectively located at two sides of the detecting harmonic oscillator, a first fixed anchor, a second fixed anchor, a first metal electrode pad sputtered on the first fixed anchor, a third capacitor plate located at an opposite side of the first capacitor plate and fixed to the second fixed anchor, and a second metal electrode pad sputtered on the second fixed anchor, wherein two ends of the detecting harmonic oscillator are respectively connected with a corresponding pair of magnifying beams and the first fixed anchor; the first capacitor plate and the third capacitor plate form a first plate capacitor.

13: The MEMS full-scale tilt sensor based on synchronous oscillation frequency detection, as recited in claim 12, wherein: each of the three synchronization units comprises a synchronization harmonic oscillator which is a main part of each of the three synchronization units, a fourth capacitor plate and a fifth capacitor plate both of which are respectively located at two sides of the synchronization harmonic oscillator, a third fixed anchor and a fifth fixed anchor both of which are respectively located at a top end and a bottom end of the synchronization harmonic oscillator, a fourth fixed anchor, a third metal electrode pad sputtered on the third fixed anchor, a sixth capacitor plate located at an opposite side of the fourth capacitor plate and fixed to the fourth fixed anchor, a fourth metal electrode pad sputtered on the fourth fixed anchor, wherein the fourth capacitor plate and the sixth capacitor plate form a second plate capacitor, the fifth capacitor plate is opposite to the second capacitor plate to form a third plate capacitor.

14: The MEMS full-scale tilt sensor based on synchronous oscillation frequency detection, as recited in claim 11, wherein: every oscillating circuit with automatic gain control comprises a feedthrough current cancellation circuit, an amplifier, a bandpass filter or a PLL (phase-lock loop), a phase shifting circuit, a comparator and an amplitude adjustment circuit connected with each other in sequence, wherein the feedthrough current cancellation circuit is connected with the first metal electrode pad or the third metal electrode pad, the amplitude adjustment circuit is connected with the second metal electrode pad or the fourth metal electrode pad.

15: The MEMS full-scale tilt sensor based on synchronous oscillation frequency detection, as recited in claim 11, wherein: the sensor comprises a monocrystalline silicon substrate, an insulating layer grown on the monocrystalline silicon substrate, and a monocrystalline silicon structural layer grown on the insulating layer, wherein the monocrystalline silicon structural layer comprises the hexagonal mass block, the three pairs of magnifying beams, the three detecting units and the three synchronization units; the monocrystalline silicon substrate plays a support role for ensuring that the monocrystalline silicon structural layer is hung and is able to freely vibrate.

16: The MEMS full-scale tilt sensor based on synchronous oscillation frequency detection, as recited in claim 12, wherein: the sensor comprises a monocrystalline silicon substrate, an insulating layer grown on the monocrystalline silicon substrate, and a monocrystalline silicon structural layer grown on the insulating layer, wherein the monocrystalline silicon structural layer comprises the hexagonal mass block, the three pairs of magnifying beams, the three detecting units and the three synchronization units; the monocrystalline silicon substrate plays a support role for ensuring that the monocrystalline silicon structural layer is hung and is able to freely vibrate.

17: The MEMS full-scale tilt sensor based on synchronous oscillation frequency detection, as recited in claim 13, wherein: the sensor comprises a monocrystalline silicon substrate, an insulating layer grown on the monocrystalline silicon substrate, and a monocrystalline silicon structural layer grown on the insulating layer, wherein the monocrystalline silicon structural layer comprises the hexagonal mass block, the three pairs of magnifying beams, the three detecting units and the three synchronization units; the monocrystalline silicon substrate plays a support role for ensuring that the monocrystalline silicon structural layer is hung and is able to freely vibrate.

18: The MEMS full-scale tilt sensor based on synchronous oscillation frequency detection, as recited in claim 14, wherein: the sensor comprises a monocrystalline silicon substrate, an insulating layer grown on the monocrystalline silicon substrate, and a monocrystalline silicon structural layer grown on the insulating layer, wherein the monocrystalline silicon structural layer comprises the hexagonal mass block, the three pairs of magnifying beams, the three detecting units and the three synchronization units; the monocrystalline silicon substrate plays a support role for ensuring that the monocrystalline silicon structural layer is hung and is able to freely vibrate.

19: The MEMS full-scale tilt sensor based on synchronous oscillation frequency detection, as recited in claim 11, wherein: one pair of the three pairs of magnifying beams, one of the three detecting units and one of the three synchronization units form a whole; and the three pairs of magnifying beams, the three detecting units and the three synchronization units are respectively radially evenly distributed at the periphery of the mass block as the whole.

20: The MEMS full-scale tilt sensor based on synchronous oscillation frequency detection, as recited in claim 12, wherein: one pair of the three pairs of magnifying beams, one of the three detecting units and one of the three synchronization units form a whole; and the three pairs of magnifying beams, the three detecting units and the three synchronization units are respectively radially evenly distributed at the periphery of the mass block as the whole.

21: The MEMS full-scale tilt sensor based on synchronous oscillation frequency detection, as recited in claim 13, wherein: one pair of the three pairs of magnifying beams, one of the three detecting units and one of the three synchronization units form a whole; and the three pairs of magnifying beams, the three detecting units and the three synchronization units are respectively radially evenly distributed at the periphery of the mass block as the whole.

22: The MEMS full-scale tilt sensor based on synchronous oscillation frequency detection, as recited in claim 14, wherein: one pair of the three pairs of magnifying beams, one of the three detecting units and one of the three synchronization units form a whole; and the three pairs of magnifying beams, the three detecting units and the three synchronization units are respectively radially evenly distributed at the periphery of the mass block as the whole.

23: The MEMS full-scale tilt sensor based on synchronous oscillation frequency detection, as recited in claim 12, wherein: a distance between the first capacitor plate and the third capacitor plate, a distance between the fourth capacitor plate and the sixth capacitor plate, and a distance between the fifth capacitor plate and the second capacitor plate are in a range of 0.1-2 μm.

24: The MEMS full-scale tilt sensor based on synchronous oscillation frequency detection, as recited in claim 13, wherein: a distance between the first capacitor plate and the third capacitor plate, a distance between the fourth capacitor plate and the sixth capacitor plate, and a distance between the fifth capacitor plate and the second capacitor plate are in a range of 0.1-2 μm.

25: The MEMS full-scale tilt sensor based on synchronous oscillation frequency detection, as recited in claim 14, wherein: a distance between the first capacitor plate and the third capacitor plate, a distance between the fourth capacitor plate and the sixth capacitor plate, and a distance between the fifth capacitor plate and the second capacitor plate are in a range of 0.1-2 μm.

26: A frequency measurement method of an MEMS (micro-electromechanical system) full-scale tilt sensor based on synchronous oscillation frequency detection, which comprises steps of: providing a first oscillating circuit and a second oscillating circuit with automatic gain control, disposing a detecting unit in the first oscillating circuit and disposing a synchronization unit in the second oscillating circuit, respectively forming self-oscillation at a natural frequency of the detecting unit and the synchronization unit, achieving a synchronous self-oscillation of the detecting unit and the synchronization unit through an electrostatic coupling of the three plate capacitor to greatly reduce background noise thereof for improving a frequency stability of the detecting unit; when a self-oscillation frequency ratio of the first oscillating circuit to the second oscillating circuit is a certain value, a frequency variation of the detecting unit is synchronously amplified to improve a detection sensitivity of the detecting unit.

27: An angle measurement method of an MEMS (micro-electromechanical system) full-scale tilt sensor based on synchronous oscillation frequency detection, which comprises steps of: a mass block sensing an in-plane gravitational acceleration and simultaneously generating a stress or tension to three pairs of magnifying beams, the three pairs of magnifying beams amplifying the stress or tension and then applying to three detecting units, changing an inherent frequency of a detecting harmonic oscillator of each of the three detecting units, respectively disposing each of the three detecting units and each of three synchronization units in a first oscillating circuit and a second oscillating circuit with automatic gain control, forming three synchronous self-oscillation circuits, detecting an oscillating frequency and an oscillating frequency variation of each of the three synchronous oscillating circuits, and deducing an inclination value of the sensor.

28: The angle measurement method of the MEMS full-scale tilt sensor based on synchronous oscillation frequency detection, as recited in claim 27, wherein: the first oscillating circuit and the second oscillating circuit are synchronously vibrated through an electrostatic coupling of the third plate capacitor, so as to greatly reduce a background noise of the first oscillating circuit and the second oscillating circuit for improving a frequency stability of the three detecting units; when the self-oscillating frequency ratio of the first oscillating circuit and the second oscillating circuit is 1:1, 1:3 or 1:9, the frequency variation of the three detecting units is synchronously amplified, so as to improve a detection sensitivity of the three detecting units.
